(19) United States
(12) Patent Application Publication
(10) Pub. No.: US 2018/0348030 A1
(43) Pub. Date: Dec. 6, 2018

(54) SENSOR WITH A GAS FLOW SENSING CHIP FOR MEASUREMENT OF FLOW RATE OF A GAS FLOWING THROUGH A GAS CONDUIT

(71) Applicant: KITA SENSOR TECH. CO., LTD., New Taipei City (TW)

(72) Inventors: Chao-Lin CHEN, Taipei City (TW); Min Lwin MAO, Kumamoto City (JP)

(21) Appl. No.: 15/957,586

(22) Filed: Apr. 19, 2018

(30) Foreign Application Priority Data
Jun. 1, 2017 (TW) 106118040
Jun. 1, 2017 (TW) 106207783

(51) Int. Cl. G01F 1/684; G01F 15/14; G01L 19/14

(52) U.S. Cl. CPC G01F 1/6847; G01L 19/147; G01F 15/14

(57) ABSTRACT

A sensor includes a sensor device mounted in a sensor housing which defines therein a gas conduit to permit a gas to flow therethrough in a predetermined flowing direction. The sensor device includes a sensor module having a sensor circuit board, a gas flow sensing chip and a plurality of first deflecting members. The gas flow sensing chip is disposed on a major surface of the sensor circuit board that faces the gas conduit so as to measure the flow rate of the gas flowing through the gas conduit. The first deflecting members are disposed on and protrude from the major surface, and are elongated in the flowing direction so as to rectify the gas flowing therealong. The rectified gas is subsequently guided to flow over the gas flow sensing chip for flow rate measurement.

### CROSS-REFERENCE TO RELATED APPLICATION

This application claims priority of Taiwanese Patent Application No. 106118040, filed on Jun. 1, 2017, and Taiwanese Patent Application No. 106207783, filed on Jun. 1, 2017.

### FIELD

The disclosure relates to a sensor, and more particularly to a sensor with a gas flow sensing chip for measuring flow rate of a gas flowing through a gas conduit in a sensor housing.

### BACKGROUND

Referring to FIGS. 1 and 2, a conventional thermal mass flow sensor includes a circuit board 11 and a gas flow sensing chip 12 disposed on a major surface 111 of the circuit board 11. The circuit board 11 and the gas flow sensing chip 12 are placed on a gas flow path. The gas flow sensing chip 12 is disposed to heat the gas flow therethrough and to measure the temperature difference before and after heating for determining the flow rate of the gas.

Since conductive lines 112 made of copper foil are soldered on and protrude from the major surface 111 of the circuit board 11 and generally extend in a direction transverse to that of the gas flow 13, turbulent flow is generated when the gas flows through the conductive lines 112. Moreover, the gas flow sensing chip 12 also protrudes from the major surface 111 of the circuit board 11, and another turbulent flow is generated when the gas flows through the gas flow sensing chip 12. As a result, the gas flow 13 is unsteady and unsmooth, which adversely affects the accuracy of the flow measurement of the gas flow sensing chip 12.

On the other hand, the conventional thermal mass flow sensor can be employed in a carrying mechanism which holds an object through a vacuum nozzle. The vacuum nozzle is connected with a negative pressure gas supply through a gas transferring tube. The thermal mass flow sensor is disposed in the gas transferring tube to sense the gas flow therein to determine whether the object is held by the vacuum nozzle. When the object is properly held by the carrying mechanism, the flow rate of the gas in the gas transferring tube is measured to be zero, and an “ON” state is shown on the thermal mass flow sensor. However, when the negative pressure gas supply is broken and the negative pressure is not supplied to hold an object, the flow rate of the gas in the gas transferring tube is also measured to be zero, which leads to inaccuracy in determining whether or not the object is properly held by the carrying mechanism using the conventional thermal mass flow sensor.

### SUMMARY

Therefore, an object of the disclosure is to provide a sensor that can alleviate at least one of the drawbacks of the prior art.

According to the disclosure, the sensor includes a sensor housing and a sensor device. The sensor housing is configured to define therein a gas conduit which permits a gas to flow therethrough in a first flowing direction. The sensor device is disposed in the sensor housing, and includes a sensor module. The sensor module includes a sensor circuit board, a gas flow sensing chip and a plurality of first deflecting members. The sensor circuit board has a first major surface which faces the gas conduit. The gas flow sensing chip is disposed on the first major surface to measure the flow rate of the gas flowing through the gas conduit. The gas flow sensing chip has a sensing surface which has a first side edge. The first deflecting members are disposed on and protrude from the first major surface. Each of the first deflecting members is elongated in the first flowing direction to have a proximate end spaced apart and adjacent to the first side edge so as to rectify the gas flowing therealong followed by flowing of the gas over the sensing surface of the gas flow sensing chip.

### BRIEF DESCRIPTION OF THE DRAWINGS

Other features and advantages of the disclosure will become apparent in the following detailed description of the embodiments with reference to the accompanying drawings, of which:

FIG. 1 is a fragmentary perspective view of a circuit board of a conventional thermal mass flow sensor;

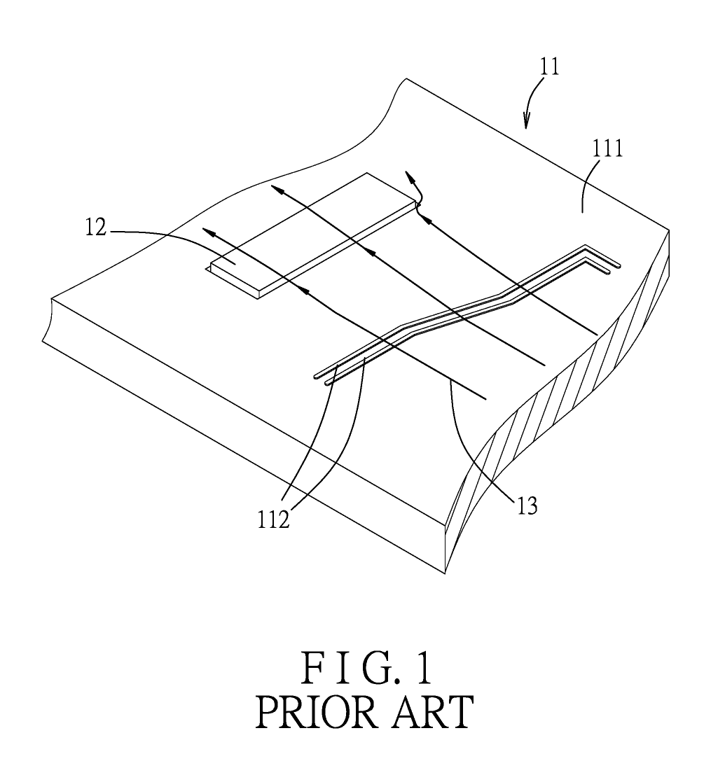

FIG. 2 is a side view of FIG. 1;

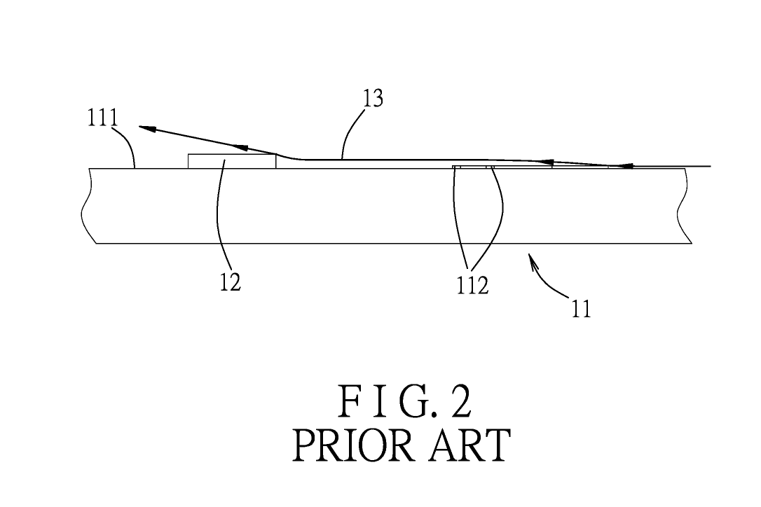

FIG. 3 is a perspective view illustrating a first embodiment of a sensor according to the disclosure;

FIG. 4 is a sectional view taken along line S1-S1 of FIG. 3;

FIG. 5 is a partly exploded perspective view of the first embodiment;

FIG. 6 is a perspective view illustrating a sensor module of the first embodiment;

FIG. 7 is a sectional view taken along line S2-S2 of FIG. 6;

FIG. 8 is a block diagram of a control module of the first embodiment;

FIG. 9 is an enlarged view of a portion of FIG. 4, illustrating direction of gas flow;

FIG. 10 is a schematic view illustrating the first embodiment utilized in a carrying mechanism and a state when an object is held by a vacuum nozzle;

FIG. 11 is a schematic view similar to FIG. 10, illustrating a state when a negative pressure gas supply is broken and the object is not held by the vacuum nozzle;

FIG. 12 is a sectional view illustrating a second embodiment of a sensor according to the disclosure;

FIG. 13 is a sectional view illustrating a third embodiment of a sensor according to the disclosure;

FIG. 14 is a fragmentary sectional view illustrating a fourth embodiment of a sensor according to the disclosure;

FIG. 15 is a fragmentary sectional view illustrating a fifth embodiment of a sensor according to the disclosure; and

FIG. 16 is a sectional view illustrating a sixth embodiment of a sensor according to the disclosure.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

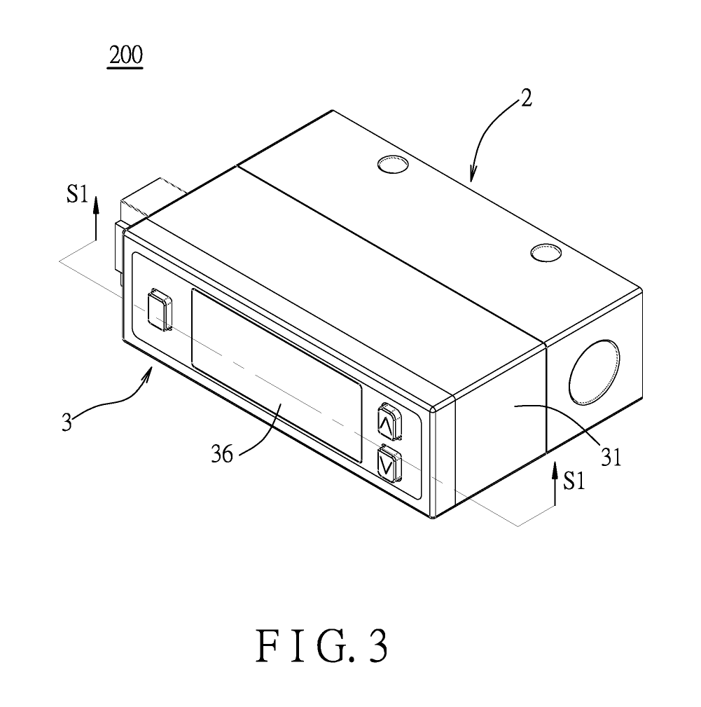

Referring to FIG. 3, a first embodiment of a sensor 200 according to the disclosure is a sensor capable of measuring flow rate and pressure of a gas, and includes a sensor housing 2 and a sensor device 3.

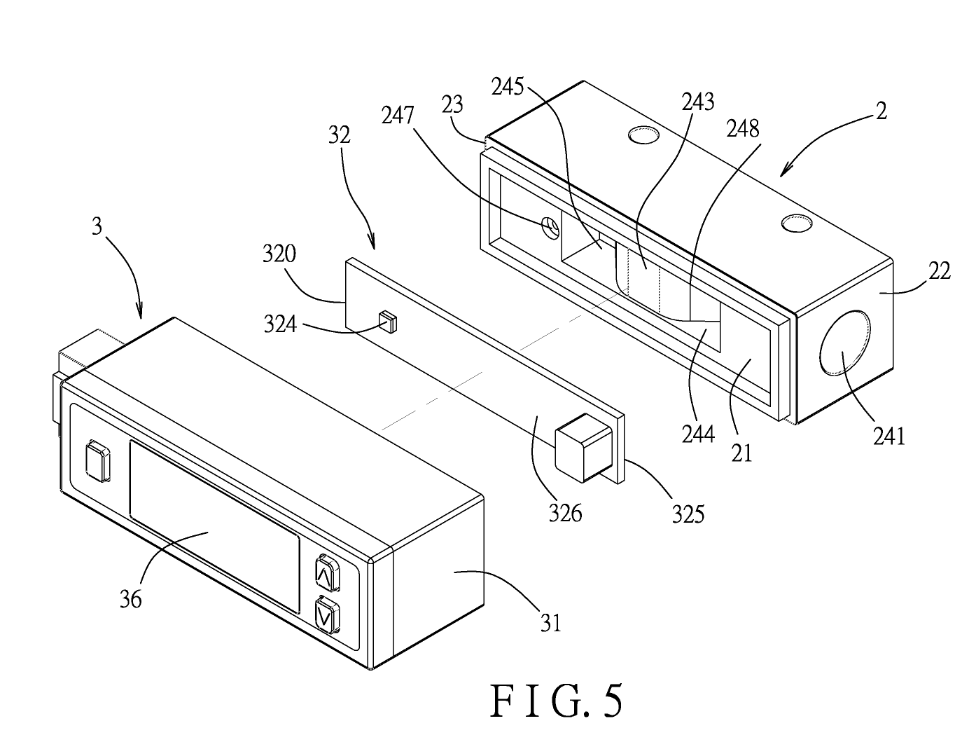

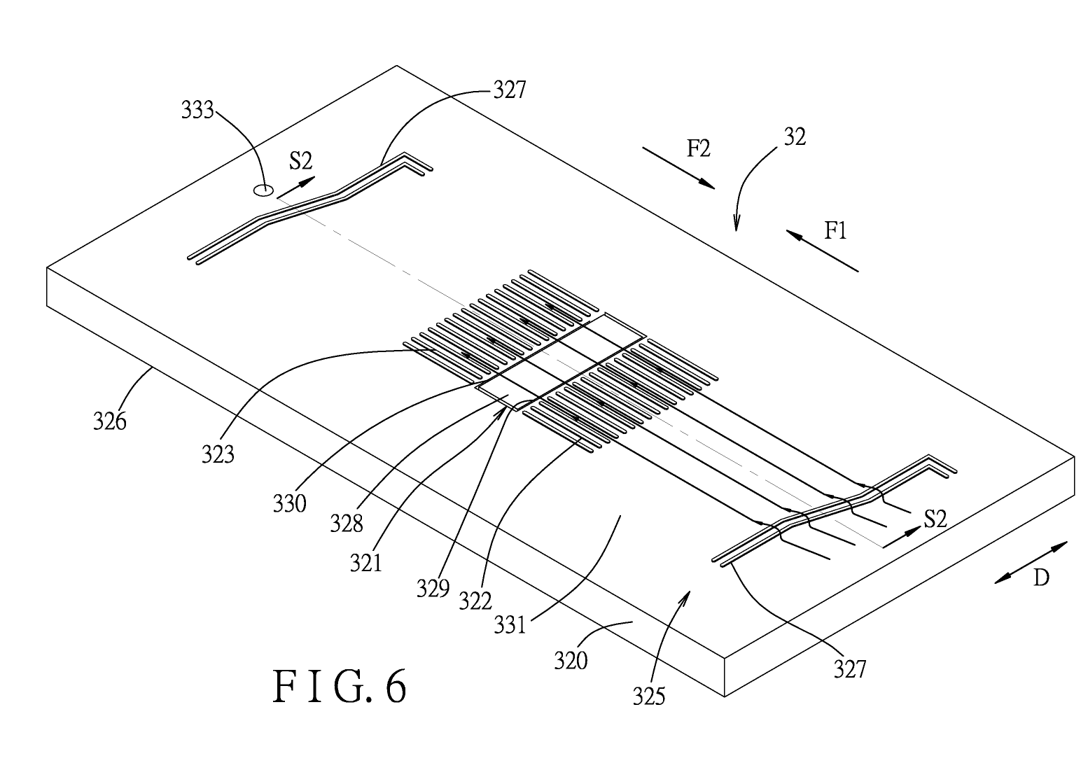

With reference to FIGS. 3 to 5, the sensor housing 2 includes a front end wall 21 and two side walls 22, 23 at left and right sides of the front end wall 21. The sensor housing 2 is configured to define a gas conduit 24 therein. The gas conduit 24 has a first channel 241, a second channel 242, a sensing channel 243, a first communicating channel 244, a second communicating channel 245, a main portion channel 246 and a bypass 247. The first channel 241 is formed in the side wall 22 for insertion of a gas inlet tube (not shown) so as to transfer gas into the gas conduit 24 through the first channel 241. The second channel 242 is formed in the side wall 23 for insertion of a gas outlet tube (not shown) so as to permit discharge of the gas from the second channel 242. The sensing channel 243 has an opened front side 248 formed in the front end wall 21. The sensing channel 243 is formed forwardly of the first and second channels 241, 242, and cooperates with the first and second channels 241, 242 to guide the gas to flow therethrough in a first flowing direction (F1) (as shown in FIG. 6). In this embodiment, the first flowing direction (F1) is a left-and-right direction.

The first and second communicating channels 244, 245 are disposed to respectively be in spatial communication with two opposite ends of the sensing channel 243 in the first flowing direction (F1) to communicate with the first and second channels 241, 242, respectively. Hence, a portion of gas flowing in the first channel 241 flows through the sensing channel 243 such that the sensor device 3 can measure the flow rate of the gas flowing in the sensing channel 243. The gas is then guided by the second communicating channel 245 to flow to the second channel 242. The main portion channel 246 is disposed to directly intercommunicate the first and second channels 241, 242 so as to permit most of the gas to flow into the second channel 242 without passing the sensor device 3. The bypass 247 extends in a front-and-rear direction and is spaced apart from the sensing channel 243 and the second communicating channel 245. The bypass 247 has a front end formed in the front end wall 21, and a rear end in spatial communication with the second channel 242 so as to permit the sensor device 3 to measure the pressure of the gas in the bypass 247.

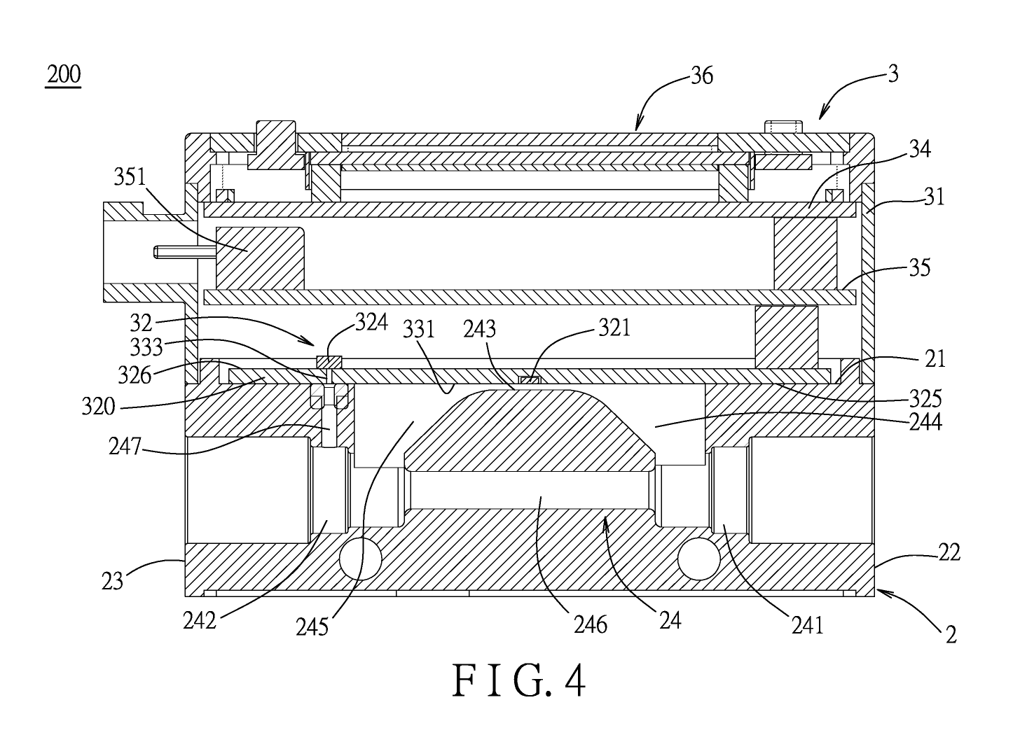

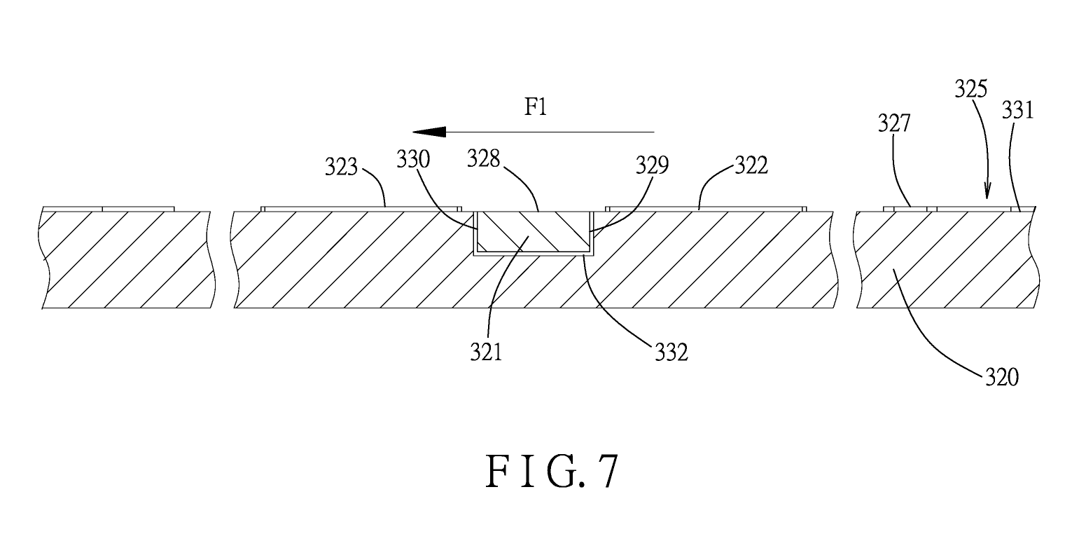

With reference to FIGS. 4 to 8, the sensor device 3 includes a front housing 31, a sensor module 32, a control module 340 and a display screen 36. The front housing 31 is coupled with and disposed forwardly of the sensor housing 2. The sensor module 32 includes a sensor circuit board 320, a gas flow sensing chip 321, a plurality of first deflecting members 322, a plurality of second deflecting members 323 and a pressure sensing chip 324. The sensor circuit board 320 has a first major surface 325 which faces rearward, and a second major surface 326 which is opposite to the first major surface 325 to face forward. The first major surface 325 faces the front end wall 21 of the sensor housing 2, the sensing channel 243, the first communicating channel 244 and the second communicating channel 245, and is attached to the front end wall 21 to close the opened front side 248 of the sensing channel 243. A plurality of conductive lines 327 made of copper foil are soldered on and protrude from the first major surface 325 of the sensor circuit board 320 for signal transmission. One portion of the conductive lines 327 are arranged in the first communicating channel 244, and another portion of the conductive lines 327 are arranged in the second communicating channel 245. In this embodiment, the gas flow sensing chip 321 is a thermal mass flow sensing chip which is disposed on the first major surface 325 and arranged corresponding to the sensing channel 243. The gas flow sensing chip 321 has a sensing surface 328 to sense and measure flow rate of the gas flowing through the sensing channel 243. The sensing surface 328 is rectangular and has a first side edge 329 and a second side edge 330 opposite to and parallel to each other and at the long sides thereof. Each of the first and second side edges 329, 330 is elongated in a transiting direction (D) that is substantially normal to the first flowing direction (F1).

The first deflecting members 322 are disposed on and protrude from the first major surface 325 of the sensor circuit board 320, and are located between the gas flow sensing chip 321 and the portion of the conductive lines 327 which are arranged in the first communicating channel 244. Each of the first deflecting members 322 is elongated in the first flowing direction (F1) to have a proximate end which is spaced apart from and adjacent to the first side edge 329 so as to rectify the gas flowing therealong followed by flowing of the gas over the sensing surface 328 of the gas flow sensing chip 321. Hence, turbulent flow is minimized when the gas flows through the conductive lines 327 and the gas is rectified to flow smoothly and steadily through the gas flow sensing chip 321 so as to provide a reliable and accurate flow rate measurement. In this embodiment, the first deflecting members 322 are arranged to be spaced apart from each other in the transiting direction (D), which facilitates the gas to flow through the first side edge 329 to the sensing surface 328 in a smooth and steady manner.

Alternatively, a gas inlet tube and a gas outlet tube may be inserted into the second and first channels 242, 241, respectively, such that a gas flow is produced and runs in a second flowing direction (F2) that is opposite to and parallel to the first flowing direction (F1). In this case, the second deflecting members 323 are disposed on and protrude from the first major surface 325, and are located between the gas flow sensing chip 321 and the other portion of the conductive lines 327 which are arranged in the second communicating channel 245. Each of the second deflecting members 323 is elongated in the second flowing direction (F2) to have a proximate end which is spaced apart from and adjacent to the second side edge 330 so as to rectify the gas flowing therealong followed by flowing of the gas over the sensing surface 328. Similarly, the gas flow is rectified to flow smoothly and steadily through the gas flow sensing chip 321 so as to provide a reliable and accurate flow measurement. Also, the second deflecting members 323 are arranged to be spaced apart from each other in the transiting direction (D), which facilitates the gas to flow through the second side edge 330 to the sensing surface 328 in a smooth and steady manner.

Moreover, in this embodiment, the first major surface 325 of the sensor circuit board 32 has a planar surface portion 331 on which the first and second deflecting members 322, 323 and the conductive lines 327 are disposed, and a recess portion 332 which is recessed from the planar surface portion 331. The gas flow sensing chip 321 is securely disposed in the recess portion 332 by welding or the like and is electronically connected with the sensor circuit board 320. The sensing surface 328 of the gas flow sensing chip 321 is coplanar with the planar surface portion 331 so as not to hinder the gas flow. Hence, the flow rate measurement of the gas flow sensing chip 321 is more reliable and accurate. Alternatively, the sensing surface 328 may be below the planar surface portion 331.

The sensor circuit board 320 has a penetrating hole 333 which extends through the first and second major surfaces 325, 326 and which is in spatial communication with the bypass 247. The pressure sensing chip 324 is disposed on the second major surface 326 and is electronically connected with the sensor circuit board 320. The pressure sensing chip 324 closes the penetrating hole 333 to measure the pressure of the gas in the penetrating hole 333 with the gas coming from the bypass 247.

With both the gas flow sensing chip 321 and the pressure sensing chip 324 disposed on the sensor circuit board 320, the sensor 200 can be used for measuring both the flow rate and the pressure of the gas in an object to be measured, and the sensor mounted on the object to be measured is relatively compact in size. Moreover, values of the flow rate and the pressure measured by the gas flow sensing chip 321 and the pressure sensing chip 324 can be displayed on the display screen 36 for convenient viewing by a user.

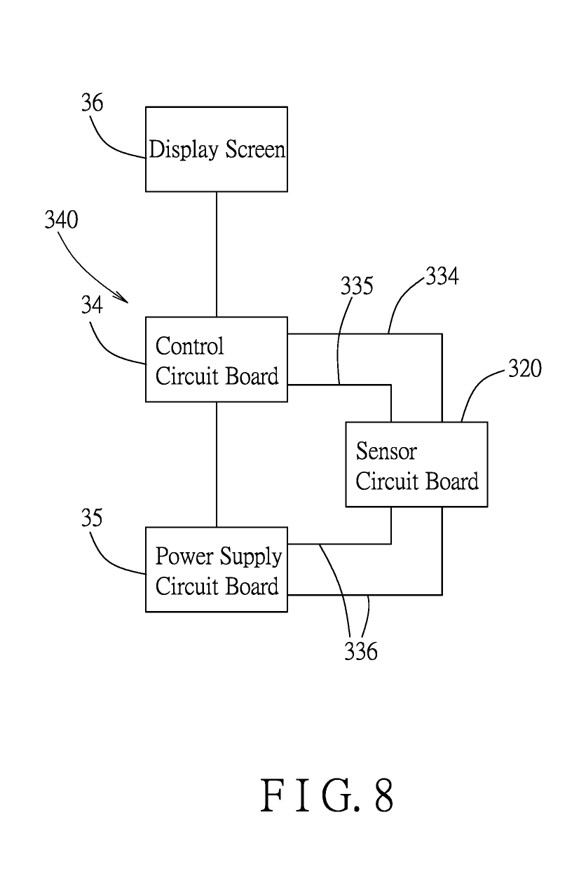

With reference to FIGS. 4 and 8, the control module 340 includes a control circuit board 34 and a power supply circuit board 35. The control circuit board 34, the power supply circuit board 35 and the display screen 36 are disposed in the front housing 31. The control circuit board 34 is electronically connected between the power supply circuit board 35 and the display screen 36. An electrical connector 351 disposed on the power supply circuit board 35 is connected with an external power line (not shown). The display screen 36 is partly exposed to the front end of the front housing 31 for the display of the measured values. The sensing module 32 further includes a first signal lead 334 which is disposed to electronically connect the sensor circuit board 320 with the control circuit board 34 to transmit a signal of the flow rate of the gas measured by the gas flow sensing chip 321, a second signal lead 335 which is disposed to electronically connect the sensor circuit board 320 with the control circuit board 34 to transmit a signal of the pressure of the gas measured by the pressure sensing chip 324, and two power supply leads 336 which are disposed to electronically connect the sensor circuit board 320 with the control circuit board 34 to transmit power from the power supply circuit board 35 to the sensor circuit board 320.

With both the gas flow sensing chip 321 and the pressure sensing chip 324 disposed on the sensor circuit board 320, the sensor module 32 can be supplied with power via the two power supply leads 336 for operation of both of the chips 321, 324. Also, the amount of the power supply leads 336 required is reduced, as compared with one in which a gas flow sensing chip and a pressure sensing chip are separately and discretely arranged, which results in reduction of manufacturing costs.

In this embodiment, the control module 340 includes the control circuit board 34 and the power supply circuit board 35 as two separate and discrete elements. In a various embodiment, the control circuit board 34 and the power supply board 35 may be integrally formed into a single board.

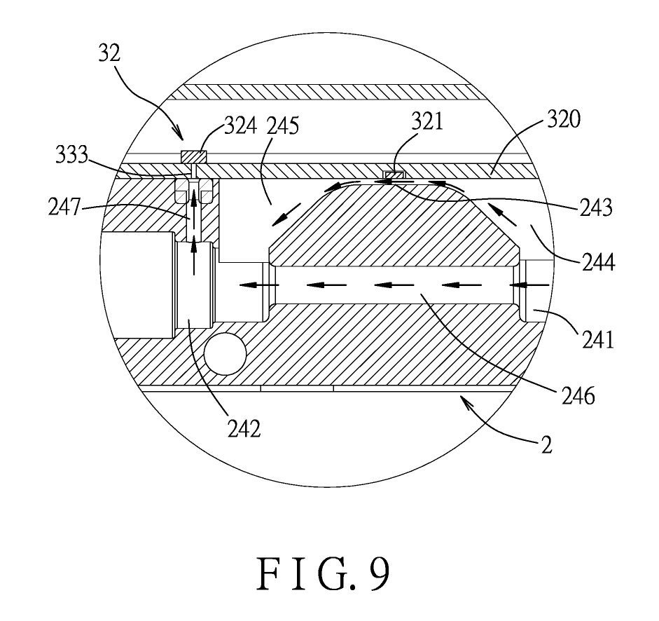

One of operation modes of the sensor 200 will be now described with reference to FIGS. 4, 6, 7 and 9. A gas inlet tube and a gas outlet tube are inserted into the first and second channels 241, 242, respectively. Gas flowing from the gas inlet tube flows through the first channel 241 and the gas conduit 24 in the first flowing direction (F1). Subsequently, a portion of the gas flows along the first communicating channel 244 into the sensing channel 243, while the other portion of the gas flows to the second channel 242 through the main portion channel 246. With the first communicating channel 244 disposed rearwardly of and gradually converged to the sensing channel 243, the portion of the gas that flows forwardly in the first communicating channel 244 contacts a portion of the conductive lines 327 to generate turbulent flows, and is then guided to flow in the first flowing direction (F1) in the sensing channel 243 and over the first deflecting members 322. The gas flow is rectified to run in a smooth and steady manner and then over the sensing surface 328 of the gas flow sensing chip 321 embedded in the recess portion 332. The gas flow is not hindered by the gas flow sensing chip 321. Hence, an accurate measurement of the flow rate of the gas can be obtained by the gas flow sensing chip 321. Subsequently, the gas flows rearwardly to the second channel 242 with a portion of the gas flowing into the bypass 247 and the penetrating hole 333 for measuring the pressure thereof by the pressure sensing chip 324. Finally, the gas is discharged from the gas outlet tube.

In this embodiment, the sensor circuit board 320 has the conductive lines 327 disposed on the first major surface 325 thereof. Alternatively, the sensor circuit board 320 may be configured without the conductive lines 327.

The gas flow sensing chip 321 detects the flow rate of the gas and produces a measured signal that is transmitted to the control circuit board 34 through the sensor circuit board 320 and the first signal lead 334 to be processed by the control circuit board 34, and a value representing the measured signal is displayed on the display screen 36. The pressure sensing chip 324 detects the pressure of the gas and produces a measured signal that is transmitted to the control circuit board 34 through the sensor circuit board 320 and the second signal lead 335 to be processed by the control circuit board 34, and a value representing the measured signal is displayed on the display screen 36.

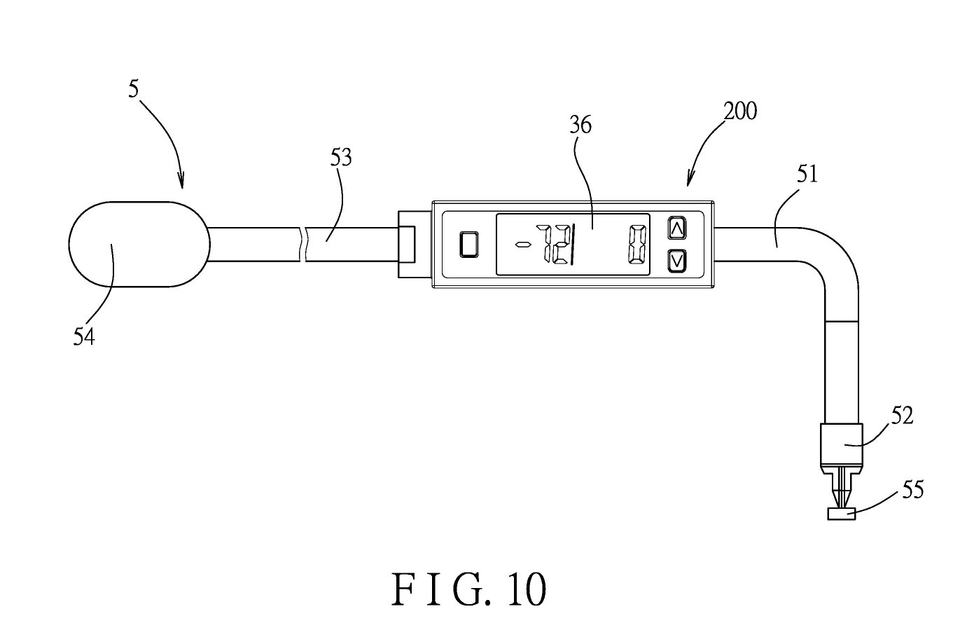

Referring to FIG. 10, the sensor 200 of this embodiment is utilized in a carrying mechanism 5. An end of a gas inlet tube 51 of the carrying mechanism 5 is connected with a vacuum nozzle 52, and an opposite end of the gas inlet tube 51 is inserted into the first channel 241 of the sensor 200 (see FIG. 4). An end of a gas outlet tube 53 of the carrying mechanism 5 is connected with a negative pressure gas supply 54, and an opposite end of the gas outlet tube 53 is inserted into the second channel 242 of the sensor 200.

In a normal operation, the vacuum nozzle 52 holds an object 55 by a negative pressure supplied by the negative pressure gas supply 54. There is no gas flowing in the sensor 200 and detected by the gas flow sensing chip 321. Hence, the value shown on the display screen 36 is 0 ml/min. Meanwhile, the pressure measured by the pressure sensing chip 324 is negative, such as −72 kPa shown on the display screen 36. An “ON” state is shown by the sensor 200 at this time the object 55 is determined to be held by the vacuum nozzle 52.

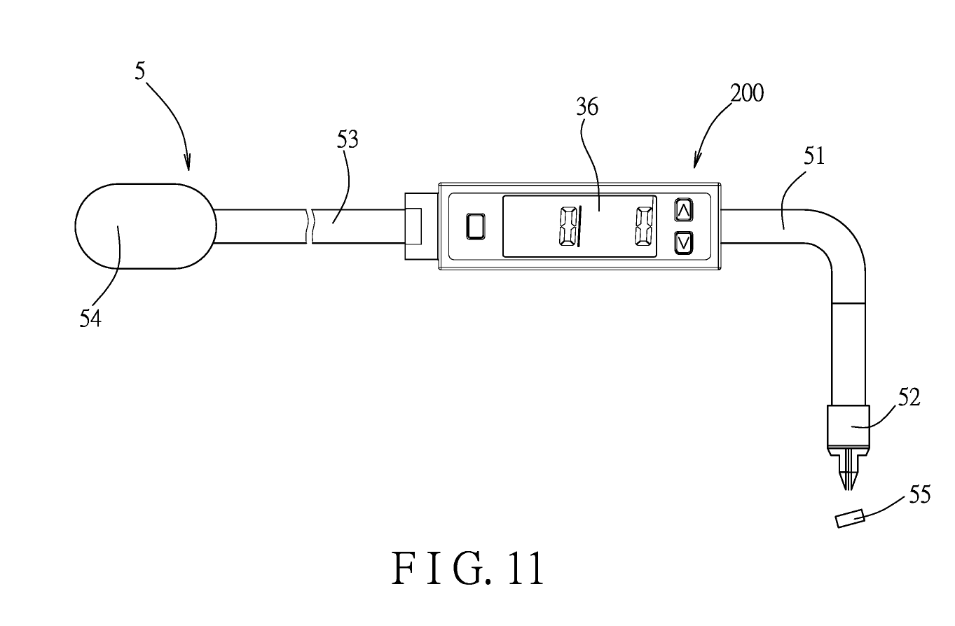

With reference to FIG. 11, once the negative pressure gas supply 54 is broken and the negative pressure is not supplied to hold the object 55, the value of the measured flow rate of gas shown from the display screen 36 is 0 ml/min. Meanwhile, the pressure measured by the pressure sensing chip 324 is no longer negative and is shown to be 0 kPa on the display screen 36. In this state, the sensor 200 will detect the malfunction of the negative pressure gas supply 54, and an “OFF” state is shown to indicate to the user that the object 55 is not held by the vacuum nozzle 52.

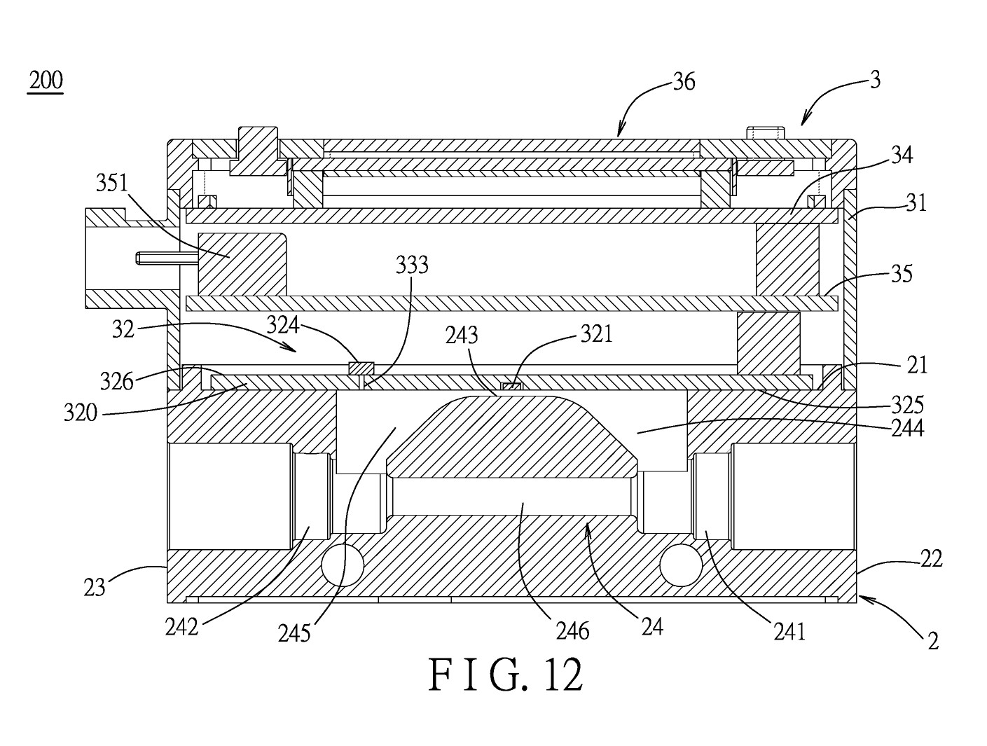

Referring to FIG. 12, in a second embodiment, the penetrating hole 333 is formed to be in spatial communication with the second communicating channel 245. The pressure sensing chip 324 is disposed on the second major surface 326 to close the penetrating hole 333 so as to measure the pressure of the gas in the penetrating hole 333 with the gas coming from the second communicating channel 245.

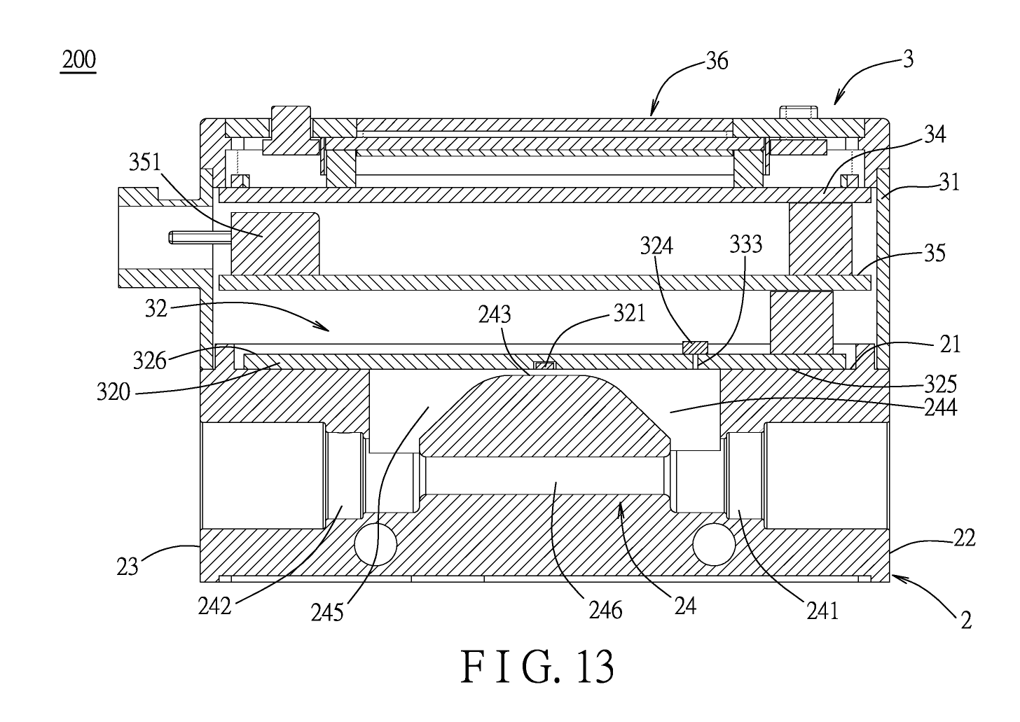

Alternatively, referring to FIG. 13, in a third embodiment, the penetrating hole 333 is formed to be in spatial communication with the first communicating channel 244. The pressure sensing chip 324 is disposed on the second major surface 326 to close the penetrating hole 333 so as to measure the pressure of the gas in the penetrating hole 333 with the gas coming from the first communicating channel 244.

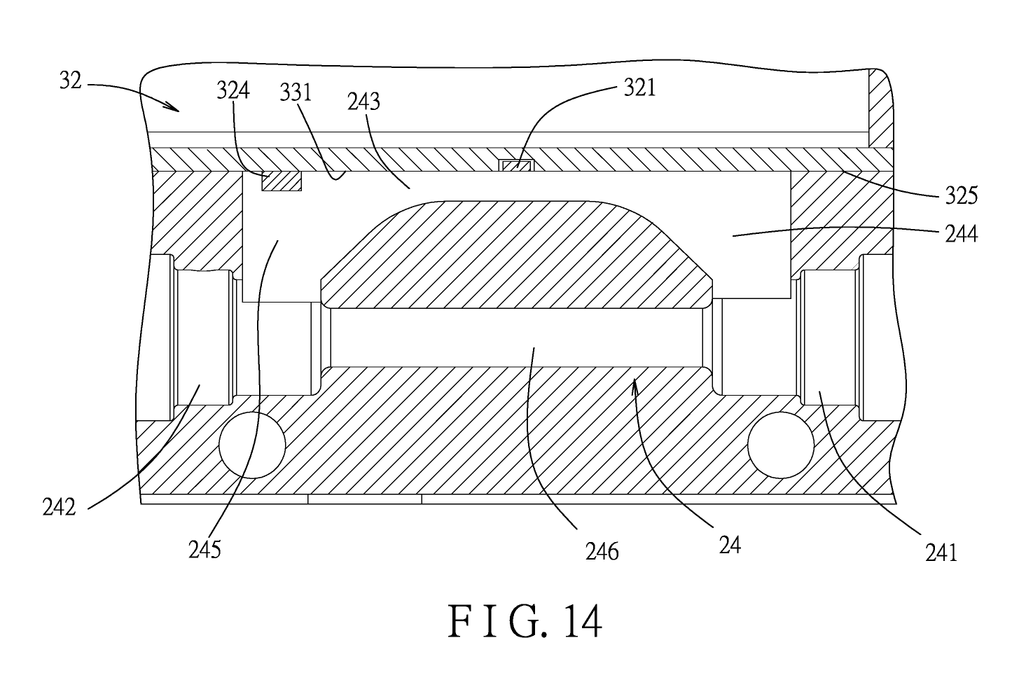

Referring to FIG. 14, in a fourth embodiment, the pressure sensing chip 324 is disposed on the planar surface portion 331 of the first major surface 325 of the sensor circuit board 320, is in the second communicating channel 245, and is disposed downstream of the gas flow sensing chip 321. Thus, the gas flows in turn over the gas flow sensing chip 321 and the pressure sensing chip 324 such that the gas flow sensing chip 321 detects and measures the flow rate of the gas followed by the measurement of the pressure of the gas by the pressure sensing chip 324.

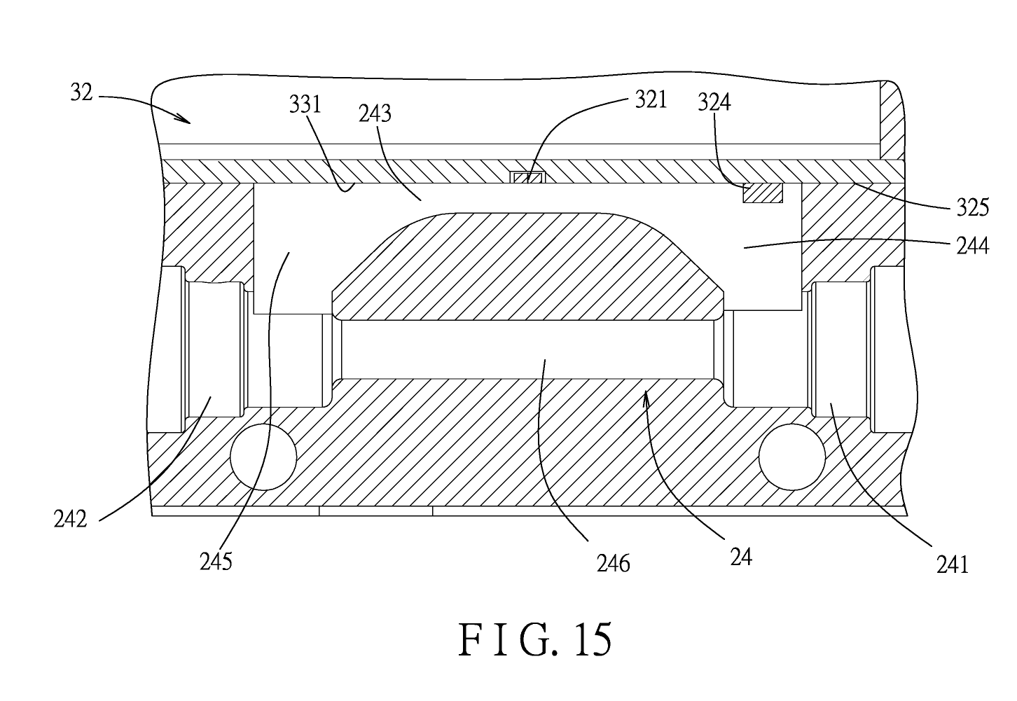

Alternatively, referring to FIG. 15, in a fifth embodiment, the pressure sensing chip 324 is disposed on the planar surface portion 331 of the first major surface 325 of the sensor circuit board 320, is in the first communicating channel 244, and is disposed upstream of the gas flow sensing chip 321. Thus, the gas flows in turn over the pressure sensing chip 324 and the gas flow sensing chip 321 such that the pressure sensing chip 324 detects and measures the pressure of the gas followed by the measurement of the flow rate of the gas by the gas flow sensing chip 321.

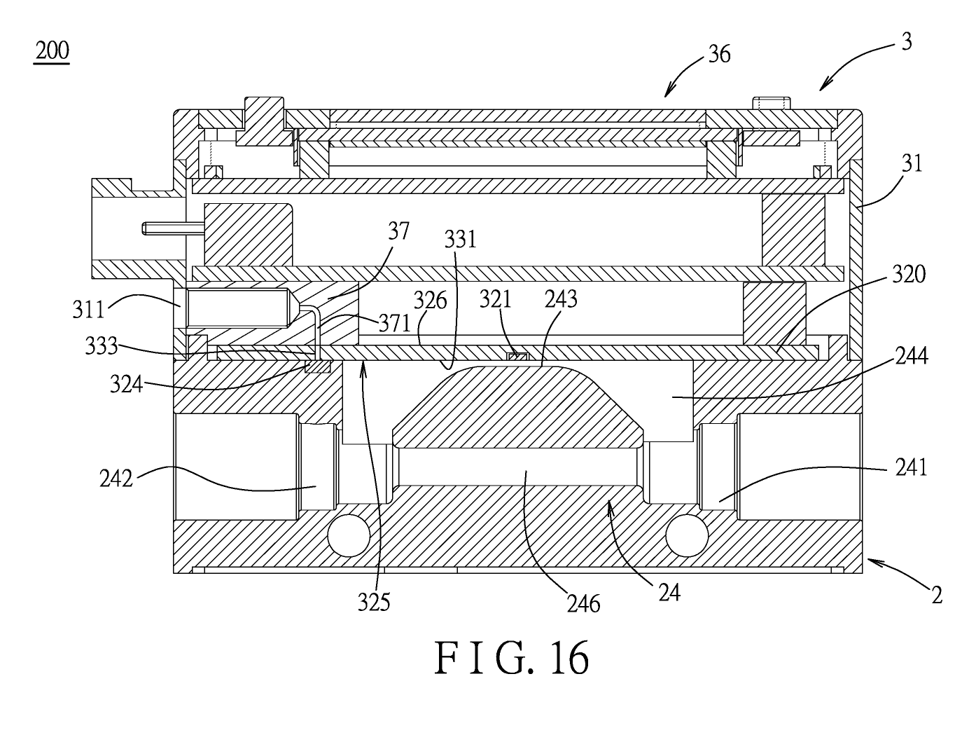

Referring to FIG. 16, in a sixth embodiment, the front housing 31 has a gas inlet hole 311 formed adjacent to the sensor circuit board 320. The sensor device 3 further includes a duct forming member 37 which is disposed in the front housing 31 and which is attached to the second major surface 326 of the sensor circuit board 320. The duct forming member 37 defines therein a duct 371 that is in spatial communication with the gas inlet hole 311 and the penetrating hole 333 and that is spaced apart from the sensing channel 243. The pressure sensing chip 324 is disposed on the first major surface 325 of the sensor circuit board 320, and closes the penetrating hole 333. In use, two tube sections of a gas inlet tube are inserted into the second channel 242 and the gas inlet hole 311, respectively, and a gas outlet pipe is inserted into the first channel 241. Whereby, gas flowing from one tube section flows through the gas conduit 24 to be detected and measured by the gas flow sensing chip 321, while gas flowing from the other tube section flows into the duct 371 and the penetrating hole 333 to be detected and measured by the pressure sensing chip 324.

As illustrated, with the first and second deflecting members 322, 323, the gas flowing in the gas conduit 24 is rectified and guided to smoothly flow through the gas flow sensing chip 321. Moreover, the gas flow sensing chip 321 is embedded in the recess portion 332 so as not to hinder the gas flow. A reliable and accurate flow rate measurement can be provided. Furthermore, with both of the gas flow sensing chip 321 and the pressure sensing chip 324 disposed on the sensor circuit board 320, the sensor 200 of the disclosure is used for measuring the flow rate and the pressure of the gas, which improves workability and flexibility, and which prevents inaccuracy in determining whether or not an object is properly held when the sensor 200 is utilized as a determination mechanism.

While the disclosure has been described in connection with what are considered the exemplary embodiments, it is understood that this disclosure is not limited to the disclosed embodiments but is intended to cover various arrangements included within the spirit and scope of the broadest interpretation so as to encompass all such modifications and equivalent arrangements.

What is claimed is:

1. A sensor comprising:
a sensor housing configured to define therein a gas conduit which permits a gas to flow therethrough in a first flowing direction; and
a sensor device disposed in said sensor housing, and including a sensor module, said sensor module including a sensor circuit board, a gas flow sensing chip and a plurality of first deflecting members, said sensor circuit board having a first major surface which faces said gas conduit, said gas flow sensing chip being disposed on said first major surface to measure the flow rate of gas flowing through said gas conduit, said gas flow sensing chip having a sensing surface which has a first side edge, said first deflecting members being disposed on and protruding from said first major surface, each of said first deflecting members being elongated in the first flowing direction to have a proximate end spaced apart and adjacent to said first side edge so as to rectify the gas flowing therealong followed by flowing of the gas over said sensing surface.

2. The sensor as claimed in claim 1, wherein said gas conduit has a sensing channel which is configured to permit the gas flow in the first flowing direction, said gas flow sensing chip being disposed in said sensing channel en route to measure the flow rate of the gas flowing through said sensing channel, said first side edge of said gas flow sensing chip being elongated in a transiting direction that is normal to the first flowing direction, said first deflecting members being spaced apart from each other in the transiting direction.

3. The sensor as claimed in claim 2, wherein said sensing channel is configured to permit the gas flow in a second flowing direction that is opposite to and parallel to the first flowing direction, said sensing surface having a second side edge which is opposite to and parallel to said first side edge, said sensor module including a plurality of second deflecting members which are disposed on and protrude from said first major surface, each of said second deflecting members being elongated in the second flowing direction to have a proximate end spaced apart and adjacent to said second side edge so as to rectify the gas flowing therealong followed by flowing of the gas over said sensing surface.

4. The sensor as claimed in claim 3, wherein said second side edge of said gas flow sensing chip is elongated in the transiting direction, said second deflecting members being spaced apart from each other in the transiting direction.

5. The sensor as claimed in claim 1, wherein said first major surface of said sensor circuit board has a planar surface portion on which said first deflecting members are disposed, and a recess portion which is recessed from said planar surface portion, said gas flow sensing chip being disposed in said recess portion to have said sensing surface coplanar with said planar surface portion or placed in said recess portion.

6. The sensor as claimed in claim 2, wherein said gas conduit has a bypass spaced apart from said sensing channel, said sensor circuit board having a second major surface opposite to said first major surface, and a penetrating hole which extends through said first and second major surfaces and which is in spatial communication with said bypass, said sensor module including a pressure sensing chip which is disposed on said second major surface and which closes said penetrating hole to measure the pressure of the gas in said penetrating hole with the gas coming from said bypass.

7. The sensor as claimed in claim 2, wherein said gas conduit has first and second communicating channels which are disposed to respectively be in spatial communication with two opposite ends of said sensing channel in the first flowing direction, said sensor circuit board having a second major surface opposite to said first major surface, and a penetrating hole which extends through said first and second major surfaces and which is in spatial communication with either one of said first and second communicating channels, said sensor module including a pressure sensing chip which is disposed on said second major surface and which closes said penetrating hole to measure the pressure of the gas in said penetrating hole with the gas coming from said either one of said first and second communicating channels.

8. The sensor as claimed in claim 2, wherein said gas conduit has first and second communicating channels which are disposed to respectively be in spatial communication with two opposite ends of said sensing channel in the first flowing direction, said sensor module including a pressure sensing chip which is disposed on said first major surface and in either one of said first and second communicating channels to measure the pressure of the gas flowing through said either one of said first and second communicating channels.

9. The sensor as claimed in claim 2, wherein said sensor device includes a front housing which is coupled with and disposed forwardly of said sensing housing and which has a gas inlet hole formed adjacent to said sensor circuit board, and a duct forming member which is disposed in said front housing and which defines therein a duct that is in spatial communication with said gas inlet hole and that is spaced apart from said sensing channel, said sensor circuit board having a second major surface opposite to said first major surface, and a penetrating hole which extends through said first and second major surfaces and which is in spatial communication with said duct, said sensor module including a pressure sensing chip which is disposed on said first major surface and which closes said penetrating hole to measure the pressure of the gas in said penetrating hole with the gas coming from said duct.

10. The sensor as claimed in claim 1, wherein said sensor module includes a pressure sensing chip which is disposed on said sensor circuit board and which is configured to measure the pressure of the gas flowing through said gas conduit.

11. The sensor as claimed in claim 10, wherein said sensor circuit board has a second major surface opposite to said first major surface, said pressure sensing chip being disposed on said second major surface and configured to measure the pressure of the gas flowing through said sensor circuit board.

12. The sensor as claimed in claim 10, wherein said pressure sensing chip is disposed on said first major surface and in said gas conduit to measure the pressure of the gas flowing through said gas conduit.

13. The sensor as claimed in claim 10, wherein said sensor device includes a control module, and said sensing module includes a first signal lead which is disposed to electronically connect said sensor circuit board with said control module to transmit a signal of the flow rate of the gas measured by said gas flow sensing chip, a second signal lead which is disposed to electronically connect said sensor circuit board with said control module to transmit a signal of the pressure of the gas flow measured by said pressure sensing chip, and two power supply leads which are disposed to electronically connect said sensor circuit board with said control module to transmit power from said control module to said sensor circuit board.
